(19) United States
(12) Patent Application Publication
(10) Pub. No.: US 2008/0310260 A1
(43) Pub. Date: Dec. 18, 2008

(54) Modular watch and device for securing a watch strap to a watch casing

(76) Inventor: Ofer Segal, Rishon Lezion (IL)

Correspondence Address: JACOBSON HOLMAN PLLC, 400 SEVENTH STREET N.W., SUITE 600, WASHINGTON, DC, 20004, US

(21) Appl. No.: 12/155,603

(22) Filed: Jun. 6, 2008

(30) Foreign Application Priority Data
Jun. 7, 2007 (IL) 183,730
May 18, 2008 (IL) 191,518

(51) Int. Cl. G04B 37/18

(52) U.S. Cl. 368/281

(57) ABSTRACT

A modular watchcase having a substantially hollow protective casing configured to hold a watch mechanism allowing passage for at least one watch control projection and a frame member configured to surround the casing and having anchor elements for the attachment of a watch strap. The frame member allows passage for the watch control projection, and a bezel ring is attachable to the enclosure without need of tools for easy interchangeability of the frame member.

### FIELD OF THE INVENTION

This invention relates to wrist watches and in particular to watchcases.

### BACKGROUND OF THE INVENTION

People commonly look upon their watches as fashion accessories. In order to keep abreast with the latest fads, retailers need to stock large numbers of watches and straps, in order to be able to offer a watch having the style and color desired by the customer. This situation is eased to some extent by stocking the watch straps unattached to the watch itself and exchanging straps, in accordance with instant requirement of the user. However, such an exchange is tricky and sometimes difficult for non-technical people, as well as time-consuming, and thus, impractical for many people. Furthermore, as known, the same applies for revolvable bezel rings, as a chosen ring can quickly be assembled to the watch. The casing of the timekeeping mechanism is, however, integral with the strap anchor lugs and cannot be changed for a different style other than the style chosen at the point of manufacture or sale. The retailer thus faces the alternatives of either not being able to meet a customer's demand for a particular style or of holding an undesirably large stock of watches, which requires capital, increased insurance coverage and carries the very real risk that the watch style stocked is superseded by a new fashion. In addition, the user may be interested in changing the appearance of the rather expensive watch and/or strap to meet day or night wear, or other style considerations, without changing the watch mechanism or face.

Modular wristwatches are known in the art. For example, U.S. Pat. No. 5,943,302 (Fanshaw) discloses a modular wristwatch assembly having a bezel and a transparent watch crystal mounted therein, first and second pairs of watch band lugs joined to opposite exterior side edge regions of the bezel, a rigid watch back member, and a rigid, annular watch movement retaining member disposed between the bezel and the back member.

The assembly includes a watch movement installed in the watch movement retaining member, having a watch face and hands for indicating the time, and operating controls extending outwardly therethrough. A decorative ring is installed between an under surface of the bezel and an upper surface of the watch face. Screws are used for detachablably attaching the bezel and the watch back member together with the watch movement retaining member and watch movement held therebetween.

Such a modular watch configuration allows factory customization of watches and also allows a salesperson to customize a watch prior to sale in accordance with a customer's specification. But the need to attach the bezel using screws puts such customization beyond the capability of the average customer, particularly bearing in mind that the screws are miniature and special tools are required.

Conventionally a watch strap has at opposite ends a tubular portion through which a spring loaded telescopic pin is inserted whose ends are accommodated in opposing recesses of a lug protruding from opposite edges of a watch casing. Such an arrangement is described, for example, in WO 98/21630. The fixing and removal of the watch strap requires use of a tool to withdraw or push back the pin connecting it to the lugs of the casing.

WO 99/36838 discloses a device for rapid fixing of a watch strap on a watch casing without a tool. This device comprises a first intermediate element mounted on the watch casing and that can slide or turn relative to this watch casing. A second intermediate element to which is fixed the watch strap, can engage the first intermediate element when the latter is in a mounting position relative to the watch casing. In normal service position of this first intermediate element relative to the watch casing, the second intermediate element is locked in a position coupled to the first intermediate element.

Swiss patent CH 614,589, discloses a watch casing whose lugs are provided with hinges, having a longitudinal recess open at the end and on the internal surface of the hinge. The bracelet is fixed to a transverse bar whose cross section has the shape of a truncated cylinder permitting in a predetermined angular position to be introduced into the recess of the hinge of the watch casing. For all the other angular positions of this bar relative to the hinge, this bar is trapped in the hinge. Here again, the watch strap can inadvertently separate from the watch casing.

U.S. Pat. No. 5,668,784 (Iguchi) discloses a watch band attachment mechanism for attaching a continuous band to a watch case by means of a pair of band attachments with holding members each having an insertion slot through which the watch band is inserted. Such an arrangement is not suitable for a conventional strap or bracelet as described above.

U.S. Pat. No. 6,408,491 (Guyard) discloses a device for securing a watch strap to a watch casing. The device includes an intermediate element to which the end of the watch strap is fixed and which is received between the lugs of the watch casing by sliding in a complementary formation on the lateral surfaces of the intermediate element and the internal surfaces of the lugs. The intermediate element comprises a flap that is resiliently pivoted about an axis transverse to the watch strap and including a locking nose that co-acts in use with a locking surface on the end surface of the watch casing.

### SUMMARY OF THE INVENTION

The present invention provides a modular watch assembly that can easily be customized by the end-user without the need for special tools.

In accordance with an embodiment of the invention, there is provided a modular watchcase, comprising:

a substantially hollow protective casing configured to hold a watch mechanism allowing passage for at least one watch control projection;

a frame member configured to surround said casing having anchor elements for the attachment of a watch strap, said frame member allowing passage for said watch control projection, and a bezel ring attachable to said enclosure without need of tools for easy interchangeability of said frame member.

Also provided in accordance with the invention is a watch mechanism kit, comprising:

a first component comprising a substantially hollow protective casing configured to hold a watch mechanism at least partially viewable through a transparent window, said casing allowing passage for at least one watch control projection;

a second component comprising a frame member configured to surround said casing and having anchor elements for the attachment of a watch strap, said frame member allowing passage for said at least one watch control projection; and

a third component comprising a bezel ring attachable to said enclosure without need of tools for easy interchangeability of said frame member;

said first component, second component and third component being mutually interchangeable for easy assembly and disassembly of said watch according to a customer's selection.

In some embodiments of the present invention there is provided a modular watchcase wherein both portions of a watch strap are connected to the frame member as part of the manufacturing process.

In some embodiments of the present invention there is provided a modular watchcase wherein the watch mechanism, with its substantially hollow protective enclosure and its transparent window, are assembled and packaged for marketing as a first item, a variety of different watch straps attached to frame members as a second item, and a variety of attachable bezel rings are provided for assembly of said watch, according to customer's wishes

In accordance with some embodiments, the invention also provides a device for attaching a conventional bracelet to a watch casing without the need for a tool and having a simpler construction than known devices.

According to such an embodiment there is provided a casing for a wrist watch, said casing comprising:

a pair of clasps protruding from opposite sides of the casing, each clasp having an open position wherein the clasp can engage an end of a bracelet and a closed position wherein the end of the bracelet is securely held by the clasp and wherein a locking element on the clasp abuts an upper rim of the casing;

said bezel ring being removably attached to an upper periphery of the casing for locking both of the clasps in their closed positions thereby preventing the respective ends of the bracelet from inadvertently disengaging.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1a, 1b and 1c show an exploded view of a watch according to an embodiment of the present invention;

FIG. 2 is a perspective view of a watch frame member with both parts of a strap attached;

FIG. 3 is a sectional view detailing the watch structure;

FIG. 4 is pictorial representation of a watch casing according to another embodiment of the invention;

FIGS. 5a, 5b and 5c show components of the watch casing depicted in FIG. 4 in spaced relationship;

FIG. 6 is a cross-sectional elevation of the watch casing as seen through the line A-A in FIG. 5b; and

FIG. 7 shows a clasp of the watch casing in an open position.

### DETAILED DESCRIPTION OF EMBODIMENTS

In the following description of some embodiments, identical components that appear in more than one figure or that share similar functionality are referenced by identical reference symbols.

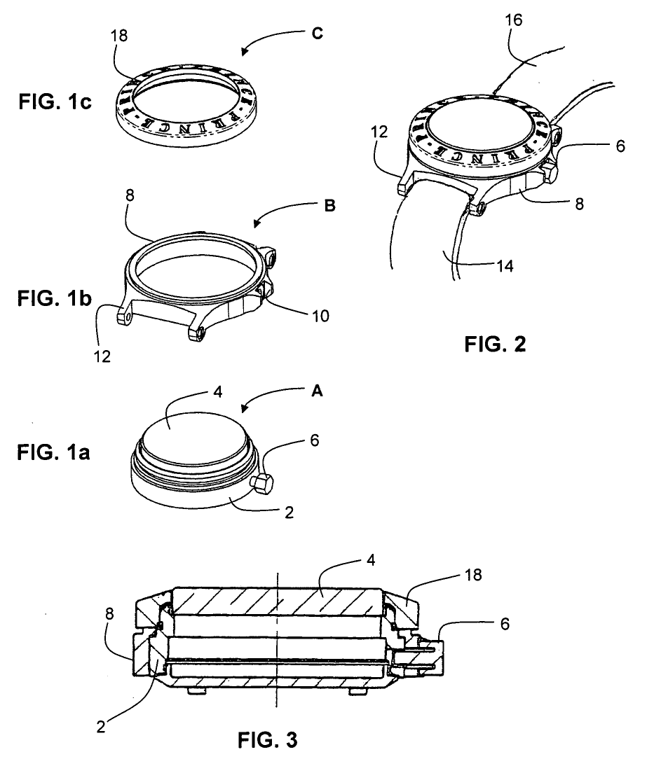

FIGS. 1a, 1b and 1c show an exploded view of a watch, according to an embodiment of the present invention. The watch is composed of three detachably interconnectable major components:

a modular watch casing shown as A in FIG. 1a;

a frame member and strap connector shown as B in FIG. 1b; and

a bezel ring shown as C in FIG. 1c.

The component A includes a casing 2 housing a watch mechanism (not shown) covered by a transparent window 4 and having a watch control knob or button 6. The watch may have several such knobs and/or buttons.

The component B is frame 8, configured to match the shape of the casing 2, and substantially surround it. For this purpose, it is made with slots or recesses 10 for accommodating the knob or button 6, when assembled. The frame 8 is further provided with lugs 12, or the like means, for anchoring interchangeable watch strap portions 14, 16 (FIG. 2).

The component C is a bezel ring 18, which is configured to be affixed to the watch casing 2. The bezel ring 18 may bear different indicia, be colored, or otherwise be ornamental, as required.

FIG. 3 is a cross-sectional view of the watch according to an embodiment of the invention. There can be seen the three components as assembled including the watch mechanism casing bottom cover 20 which, as known per se, is detachably attached to the casing by press-fitting or threaded thereon. Similarly, the coupling between the casing 2 and the bezel ring can be accomplished by suitable threads or by press-fitting. Upon the insertion of the casing 2 into the frame 8, the upper part of the casing 2, and sometimes the transparent window 4, project from the top of the frame 8, thereby allowing coupling of the bezel ring 18 on to the casing 2, and clamping the frame 8 in between.

Each of the three components A, B and C may easily be individually replaced by a similar component with any need of special tools to thereby change the appearance of the watch, as desired.

While the figures illustrate the components A, B and C to have a generally circular configuration, it is noted that other configurations such as square, rectangular, oval, or the like, may be used. In such configurations, the components may most conveniently be coupled using a snap-fitting action, particularly the bezel ring 18 to the casing 2.

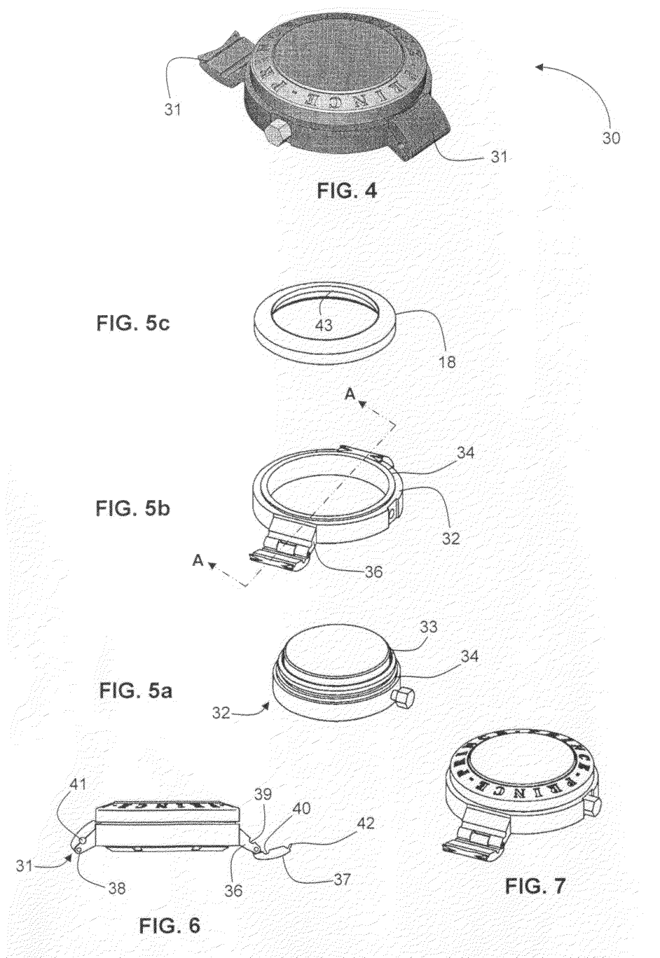

FIG. 4 is pictorial representation of a watch casing 30 according to another embodiment having a pair of clasps 31 protruding from opposite sides of the casing 30. FIGS. 5a, 5b and 5c show components of the watch casing 30 in spaced relationship. Thus, FIGS. 5a and 5b show a base portion 32 that accommodates a watch mechanism 33 in known manner. The base portion 32 has a peripheral upper rim 34 adapted for screw mounting of the bezel ring 18 that serves as a locking ring shown in FIG. 5c. Each of the clasps 31 comprises a respective lug 36 protruding from opposite edges of the base portion 32 at the 6 o'clock and 32 o'clock positions. Locking portions 37 are hingedly attached to respective first ends of the lugs 36 via pins 38. The lugs 36 and the locking portions 37 are each provided with a respective central semi-circular recess 39 and 40 so that when the locking portions 37 are closed as shown on the left side of FIG. 6, there is a formed a circular aperture 21 for accommodating a mounting pin of a watch bracelet (not shown). To this end, the bracelet is provided with its own integral mounting pins at opposite ends thereof. FIG. 7 shows the clasp 31 in an open position.

The locking portions 37 are each provided at respective second ends thereof remote from their respective points of attachment to the lugs 36 with respective outwardly protruding lips 22 which are configured to lie on the peripheral rim 34 of the base portion 32 when the clasps 31 are closed. When the bezel ring 18 is now attached to the base portion 32, the lips 22 are thus secured by the bezel ring 18 and cannot open inadvertently, thereby preventing the clasps 31 from opening. Preferably, the bezel ring 18 has an internal threaded portion 23 for screw attachment to the peripheral upper rim 34, which is provided with a complementary external thread 24. This enables the bracelet to be mounted and removed without the need for tools of any kind.

In use, the bezel ring 18 is removed simply by rotating in a counter-clockwise direction whereupon the clasps can be opened and the bracelet either removed or inserted as required. Since the bracelet has its own integral mounting pins at opposite ends thereof, the mounting pins (not shown) are simply mounted within the open recesses 39 of the lugs 36 for free rotation within the circular apertures 21 formed when the locking portions 37 are closed. The bezel ring 18 is now replaced or a different bezel ring substituted may be used, again without the need for special tools, so as to secure the bracelet.

This embodiment thus provides an effective attachment device that is very simple, robust, and easy to machine and assemble. It permits coupling and uncoupling of the watch strap from the watch casing easily and without any tool, but, because of the locking, it prevents any inadvertent separation of the bracelet from the casing.

Although this embodiment is of particular benefit when the bezel ring is threadably attached to the periphery of the base portion, it will be appreciated that it may also be adapted for press-fit mounting on to the peripheral rim of the base portion.

Likewise, although the lugs of the clasps are shown protruding from opposite edges of the base portion, their manner of attachment is not a feature of the invention. They may be machine mounted to the base portion or may be accommodated in opposite recesses formed in the base portion.

Other modifications will be apparent to those skilled in the art without departing from the scope of the appended claims.

1. A modular watchcase, comprising:
a substantially hollow protective casing configured to hold a watch mechanism allowing passage for at least one watch control projection;
a frame member configured to surround said casing having anchor elements for the attachment of a watch strap, said frame member allowing passage for said watch control projection, and
a bezel ring attachable to said enclosure without need of tools for easy interchangeability of said frame member.

2. The watchcase according to claim 1, wherein said casing further comprises a transparent window at an upper surface thereof.

3. The watchcase according to claim 1, wherein said watch control projection includes at least one watch control knob or button.

4. The watchcase according to claim 3, wherein the frame member comprises at least one notch or recess for accommodating the knob or button, when assembled.

5. The watchcase according to claim 1, wherein the anchor elements are attached to a non-detachable strap.

6. The watchcase according to claim 1, wherein the bezel ring is attachable to the upper portion of said casing.

7. The watchcase according to claim 1, wherein the casing contains a watch mechanism.

8. A watch mechanism kit, comprising:
a first component comprising a substantially hollow protective casing configured to hold a watch mechanism at least partially viewable through a transparent window, said casing allowing passage for at least one watch control projection;
a second component comprising a frame member configured to surround said casing and having anchor elements for the attachment of a watch strap, said frame member allowing passage for said at least one watch control projection; and
a third component comprising a bezel ring attachable to said enclosure without need of tools for easy interchangeability of said frame member;
said first component, second component and third component being mutually interchangeable for easy assembly and disassembly of said watch according to a customer's selection.

9. The modular watchcase according to claim 1, wherein the casing comprises:
a pair of clasps protruding from opposite sides of the casing, each clasp having an open position wherein the clasp can engage an end of a bracelet and a closed position wherein the end of the bracelet is securely held by the clasp and wherein a locking element on the clasp abuts an upper rim of the casing;
said bezel ring being removably attached to an upper periphery of the casing for locking both of the clasps in their closed positions thereby preventing the respective ends of the bracelet from inadvertently disengaging.

10. The modular watchcase according to claim 9, wherein the casing includes a base portion for supporting a watch mechanism and having a peripheral upper rim adapted for securing the locking ring.

11. The modular watchcase according to claim 10, wherein each of the clasps comprises:
a lug protruding from opposite edges of the base portion and having a central semi-circular recess,
a locking portion hingedly attached at a first end to the lug via a pin and having a central semi-circular recess,
an outwardly protruding lip at a second end of the locking portion opposite the first end thereof and being configured to lie on the peripheral rim of the base portion when the clasp is closed;
whereby when the locking portion is closed prior to securing the locking ring a circular aperture is formed for accommodating a mounting pin of a watch bracelet, and when the locking ring is now attached it secures the respective lip of each clasp thereby preventing the clasps from opening.

12. The modular watchcase according to claim 10, wherein the locking ring is adapted for threaded attachment to the peripheral rim of the base portion.

13. The modular watchcase according to claim 9, wherein the clasps are mounted in respective recesses in opposite edges of the casing.
